(19) United States
(12) Patent Application Publication
(10) Pub. No.: US 2026/0232059 A1
(43) Pub. Date: Aug. 13, 2026

(54) System and Method for Attaching a Temporary Accessory to a Wearable Item

(71) Applicant: Ann Hughes, Surprise, AZ (US)

(72) Inventor: Ann Hughes, Surprise, AZ (US)

(21) Appl. No.: 19/537,905

(22) Filed: Feb. 12, 2026

Related U.S. Application Data
(60) Provisional application No. 63/757,416, filed on Feb. 12, 2025.

(51) Int. Cl. A42B 1/24; A41D 27/08; F21L 4/00

(52) U.S. Cl. CPC A42B 1/24; A41D 27/08; A41D 27/085; F21L 4/00

(57) ABSTRACT

A temporary accessory system for wearable items includes a flexible material strip configured to conform to an accessorizable area, a fringe element extending from the fabric strip, and at least one concealed clip for removable attachment. The clip may be a spring tension clip for attachment to boot or hat rims, or a rivet system for attachment to garment seams. The flexible material includes a first face supporting the fringe and a second face supporting the clips, rendering the attachment mechanisms substantially invisible during wear. The strip length is adjustable to accommodate various item sizes. Methods of manufacturing and installing the temporary accessory are also disclosed.

### CROSS REFERENCE TO RELATED APPLICATIONS

This application claims benefit from currently pending U.S. Provisional Application No. 63/757,416 titled “System and Method for Attaching a Temporary Accessory to a Wearable Item” and having a filing date of Feb. 12, 2025, all of which is incorporated by reference herein.

### BACKGROUND OF THE INVENTION

### Field of the Invention

The present invention relates generally to removable accessories for wearable items, and more particularly to temporary decorative attachments having concealed fastening mechanisms for boots, hats, and other clothing.

### Description of Related Art

Accessories for wearable items such as boots, hats, and clothing have long been used to enhance appearance and allow customization. Traditionally, such accessories have been permanently attached through sewing, gluing, or riveting. Small removable attachments such as clip-on bows are sometime used, but larger, more elaborate accessories that can be removed and swapped out are not available. Sewing accessories onto wearable items may damage expensive footwear or clothing and prevents the accessory from being used with multiple items.

### BRIEF SUMMARY OF THE INVENTION

The present invention provides among other things a temporary accessory system for wearable items, featuring a flexible material strip with attached decorative elements and concealed fastening mechanisms. The system enables users to temporarily enhance various wearable items without permanent modification while maintaining aesthetic appeal.

It is an object of the invention to provide removable accessories that securely attach to wearable items without visible fastening mechanisms.

It is another object of the invention to accommodate different sizes and styles of wearable items through adjustable attachment means.

It is a further object of the invention to enable quick attachment and removal without damaging the base garment or accessory.

It is another object of the invention to provide a quick attachment and removal of an accessory using magnetic clips.

The above and other objects may be achieved using devices involving an attachable temporary accessory for wearable items having an accessorizable area. The accessory comprises a strip of flexible material configured to conform to the accessorizable area, a fringe element sewn to and extending from the flexible material, and at least one clip coupled to the flexible material and configured to removably attach the flexible material to the accessorizable area.

In some embodiments, the accessory further comprises a receiving rivet configured to attach to a textile and the clip is an extending rivet that detachably couples to the receiving rivet. In other embodiments, the wearable item has a rim and the at least one clip is a spring tension clip that is configured to couple over the rim. In another embodiment, the wearable item has a pull tab and the at least one clip is a spring tension clip that is configured to couple over the pull tab. When the wearable item has a rim and is a boot, the strip of flexible material may be contoured to conform to the rim of the boot. In certain embodiments, the wearable item is a hat and the strip of flexible material is a loop, and the accessory further comprises at least one magnetic attachment point.

The accessory may further comprise at least one additional decorative element interchangeably connectable to the at least one magnetic attachment point. In some embodiments, the flexible material has a first face and a second face, and the fringe element is coupled to the first face and the at least one clip is coupled to the second face such that the at least one clip is substantially invisible when the at least one clip is attached to the wearable item. The flexible material may be a strip having an adjustable length. When the strip is adjustable, the at least one clip may be at least a first clip secured to the first end and a second clip configured to be secured to the second end by a user. A covering strip may be attached to the strip of flexible material over the at least one clip to obscure the at least one clip from view.

The present invention also provides a method of attaching a temporary accessory to a wearable item. A strip of flexible material is provided and configured to conform to the accessorizable area. A fringe element is secured to the strip of flexible material and at least one clip is secured to the flexible material to removably attach the flexible material to the wearable item. Users may be instructed to secure the clip to the wearable item. In some embodiments, the at least one clip is at least one extending rivet that couples to a receiving rivet, and the receiving rivet is secured to the wearable item. The strip of flexible material may be contoured to match the contour of a rim of the wearable item.

In certain method embodiments, the flexible material has a first face and a second face, and the fringe element is attached to the first face and the at least one clip is attached to the second face so that the at least one clip is substantially invisible when attached to the wearable item. An illumination system may also be coupled to the flexible material. The method may also comprise attaching to the wearable item at least one corresponding clip that corresponds to the clip secured to the flexible material.

The invention further provides an interchangeable accessory for footwear. The accessory comprises a sleeve that fits over a portion of the footwear. At least one pull tab extends from the top of the sleeve and an accessory attachment tab is coupled to the at least one pull tab and configured to engage with a corresponding footwear tab attachment. The bottom of the sleeve is contoured with a front cutout and a back cutout with an extension between the front cutout and the back cutout. The accessory attachment tab may be a button rivet element configured to engage with a corresponding footwear button rivet element. The sleeve may have a decorative outer surface comprising at least one of trim, fringe, and illuminating decorative elements.

Aspects and applications of the invention presented here are described below in the drawings and detailed description of the invention. Unless specifically noted, it is intended that the words and phrases in the specification and the claims be given their plain, ordinary, and accustomed meaning to those of ordinary skill in the applicable arts. The inventors are fully aware that they can be their own lexicographers if desired. The inventors expressly elect, as their own lexicographers, to use only the plain and ordinary meaning of terms in the specification and claims unless they clearly state otherwise and then further, expressly set forth the “special” definition of that term and explain how it differs from the plain and ordinary meaning. Absent such clear statements of intent to apply a “special” definition, it is the inventors’ intent and desire that the simple, plain and ordinary meaning to the terms be applied to the interpretation of the specification and claims.

The inventors are also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventors are fully informed of the standards and application of the special provisions of 35 U.S.C. § 112 (f). Thus, the use of the words “function,” “means” or “step” in the Detailed Description or Description of the Drawings or claims is not intended to somehow indicate a desire to invoke the special provisions of 35 U.S.C. § 112 (f), to define the invention. To the contrary, if the provisions of 35 U.S.C. § 112 (f) are sought to be invoked to define the inventions, the claims will specifically and expressly state the exact phrases “means for” or “step for, and will also recite the word “function” (i.e., will state “means for performing the function of [insert function]”), without also reciting in such phrases any structure, material or act in support of the function. Thus, even when the claims recite a “means for performing the function of . . . “ or “step for performing the function of . . . ,” if the claims also recite any structure, material or acts in support of that means or step, or that perform the recited function, then it is the clear intention of the inventors not to invoke the provisions of 35 U.S.C. § 112 (f). Moreover, even if the provisions of 35 U.S.C. § 112 (f) are invoked to define the claimed inventions, it is intended that the inventions not be limited only to the specific structure, material or acts that are described in the preferred embodiments, but in addition, include any and all structures, materials or acts that perform the claimed function as described in alternative embodiments or forms of the invention, or that are well known present or later-developed, equivalent structures, material or acts for performing the claimed function.

### BRIEF DESCRIPTION OF THE SEVERAL VIEWS OF THE DRAWINGS

A more complete understanding of the present invention may be derived by referring to the detailed description when considered in connection with the following illustrative figures. In the figures, like reference numbers refer to like elements or acts throughout the figures.

FIG. 1 depicts a side perspective view of a boot bearing a removable accessory according to one or more embodiments.

FIG. 2 depicts a side perspective and close up view of another removable accessory according to one or more embodiments.

FIG. 3 depicts a side perspective close up view of a boot bearing a partially deconstructed removable accessory according to one or more embodiments.

FIG. 4 depicts a side perspective view of a boot bearing a removable accessory according to one or more embodiments.

FIG. 5 depicts a perspective view of a a removable accessory according to one or more embodiments.

FIG. 6 depicts a side view of a sleeve removable accessory according to one or more embodiments.

FIG. 7 depicts a removable accessory and a removable lighting element corresponding to the removable accessory according to one or more embodiments.

FIG. 8 depicts a side perspective view of a boot bearing a layered removable accessory according to one or more embodiments.

FIG. 9 depicts a side perspective view of an illuminating accessory according to one or more embodiments.

FIG. 10 depicts a side perspective and close up view of tension clip removable accessory according to one or more embodiments.

FIG. 11 depicts a perspective view of a snap on removable accessory according to one or more embodiments.

FIG. 12 depicts a rear view of a jacket bearing a snap on removable accessory according to one or more embodiments.

FIG. 13 depicts an overhead perspective view of a hat bearing a magnetized loop removable accessory according to one or more embodiments.

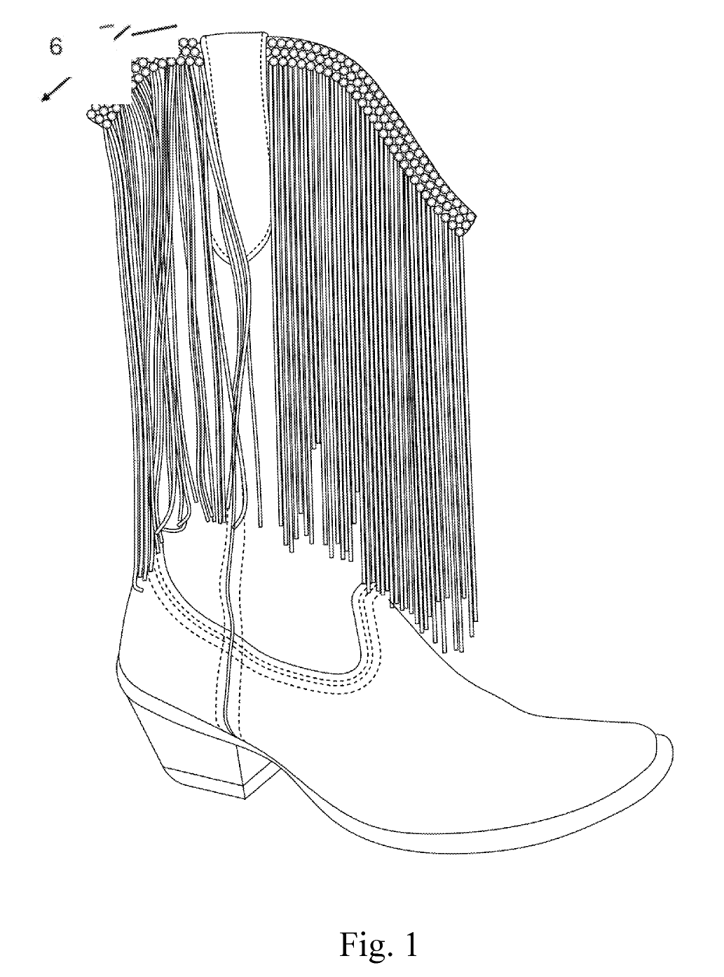

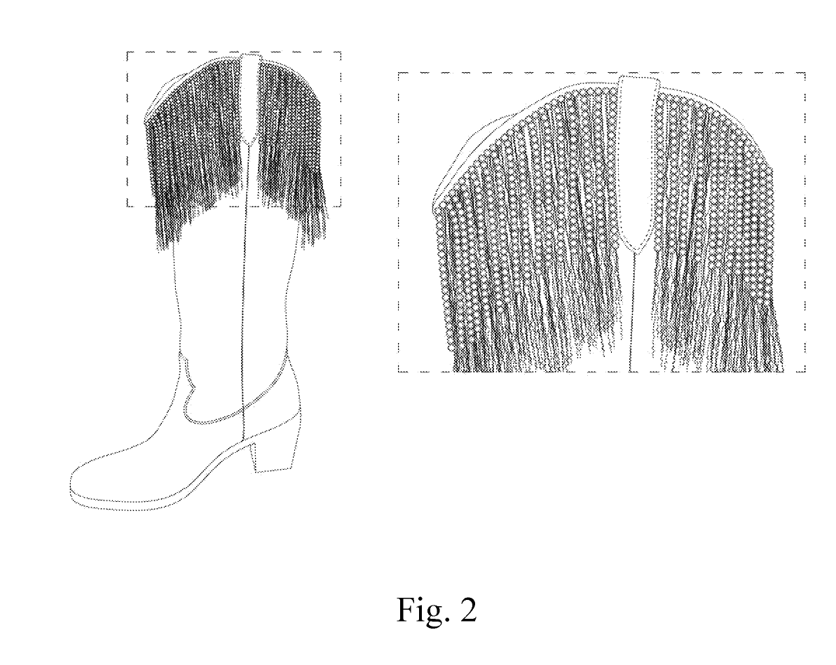

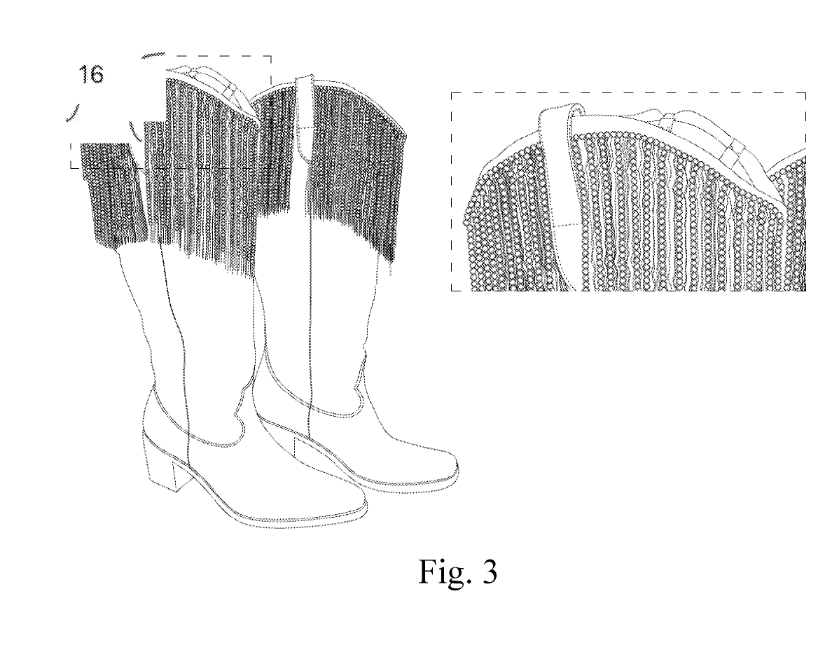

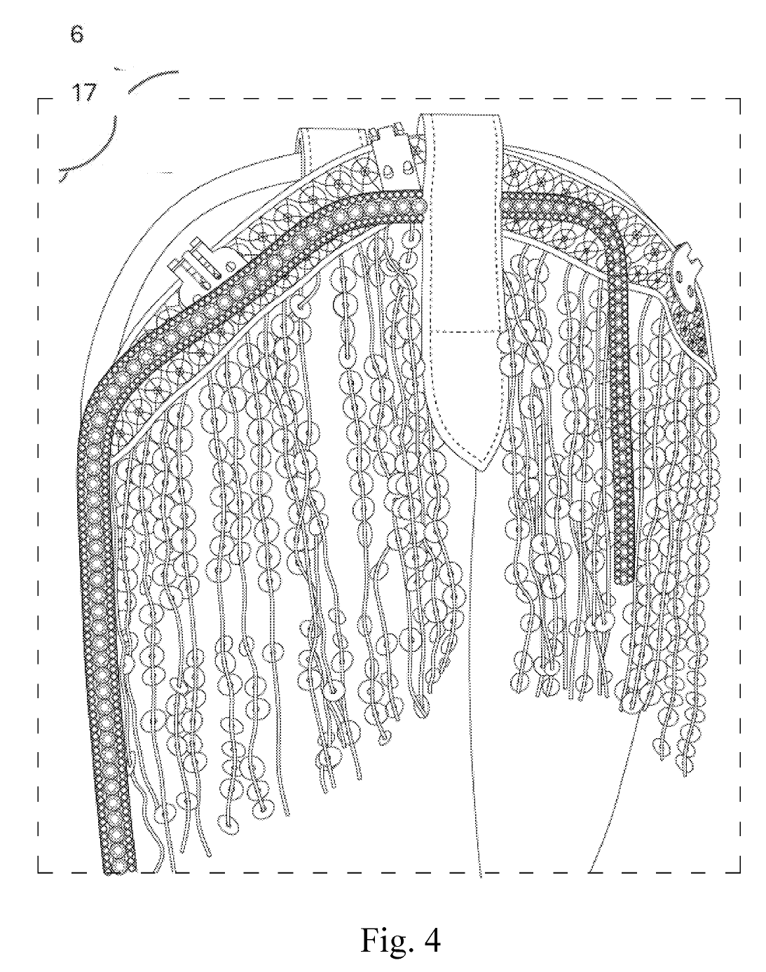

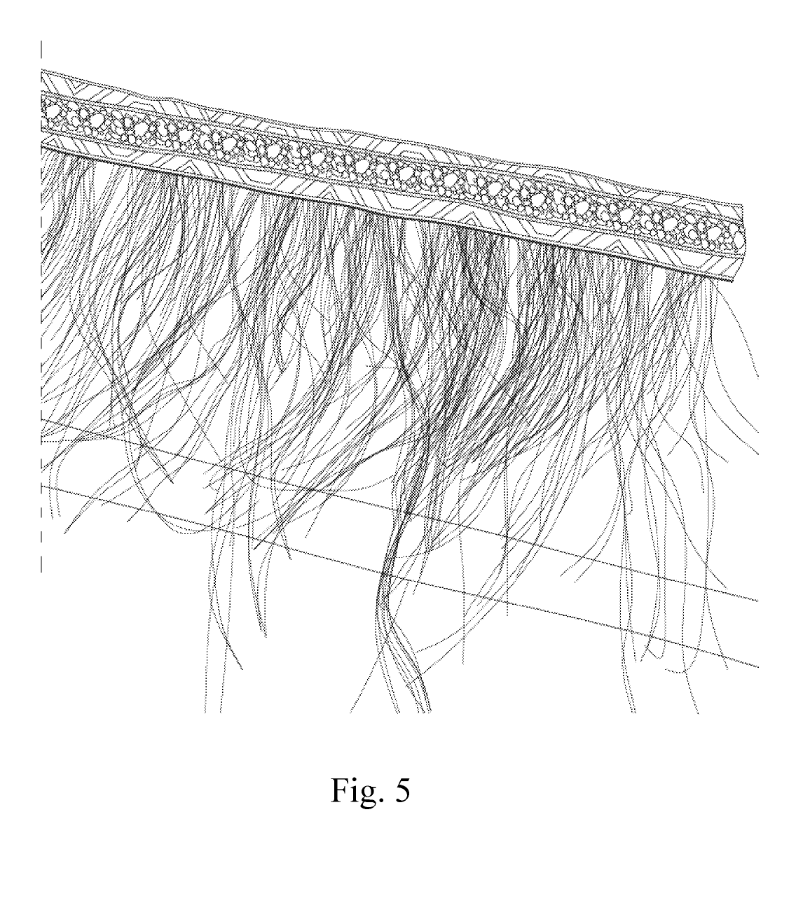

Elements and acts in the figures are illustrated for simplicity and have not necessarily been rendered according to any particular sequence or embodiment.

### DETAILED DESCRIPTION OF THE INVENTION

In the following description, and for the purposes of explanation, numerous specific details are set forth to provide a thorough understanding of the various aspects of the invention. It will be understood, however, by those skilled in the relevant arts, that the present invention may be practiced without these specific details. In other instances, known structures and devices are shown or discussed more generally to avoid obscuring the invention. In many cases, a description of the operation is sufficient to enable one to implement the various forms of the invention, particularly when the operation is to be implemented in software. It should be noted that there are many different and alternative configurations, devices, and technologies to which the disclosed inventions may be applied. The full scope of the inventions is not limited to the examples that are described below.

In one application of the invention, a detachable temporary accessory 10 is provided including a strip of flexible material 12 configured to conform to an accessorizable area 4 of a wearable item 2, a fringe element 14 extending from the flexible material 12, and at least one clip 16 coupled to the flexible material 12 for removable attachment. The wearable item may have one or more pull tabs 6. Common fabrics used for fringed clothing include suede, leather (particularly deerskin and cowhide), ultrasuede, microfiber synthetics, denim, cotton canvas, wool felt, faux leather materials, jersey knit, fleece, and heavy silk, but any material known to those having skill in the art may be used. Fringe materials commonly include feathers, leather strips, suede tassels, natural and synthetic raffia, yarn, thread, silk strands, cotton cording, jute twine, wool strips, ribbon, and metallic threads, with the material choice often matching or complementing the base fabric.

The clips 16 may be made from alligator clips with rubber/fabric coating, magnetic clips/clasps, clamshell clips, butterfly clips with pressure plates, toggle clips that rotate to lock, snap clips with push-button release, hook-style clips with safety closures, friction clips with rubber grips, or binder clips with modified arms for fabric. Clips is to have its plain and ordinary meaning and will also refers to hook and loop type fasteners.

In one embodiment, the clip 16 comprises a receiving rivet 20 configured to attach to a textile and an extending rivet 22 that detachably couples to the receiving rivet. The extending rivet 22 may attach to various locations including sleeve seams. Common methods for attaching rivet buttons to fabric include using manual hand press tools with anvil and base plate, automated pneumatic presses for industrial production, tabletop manual presses, snap-setting pliers for lightweight rivets, hole punch followed by rivet insertion, and double-cap rivets with washers for reinforcement. The choice depends on fabric thickness, rivet type, and production volume.

Considerations for which method to use include proper hole preparation (clean cut, right size) and pressure application (even, sufficient force) to ensure secure attachment without damaging the fabric.

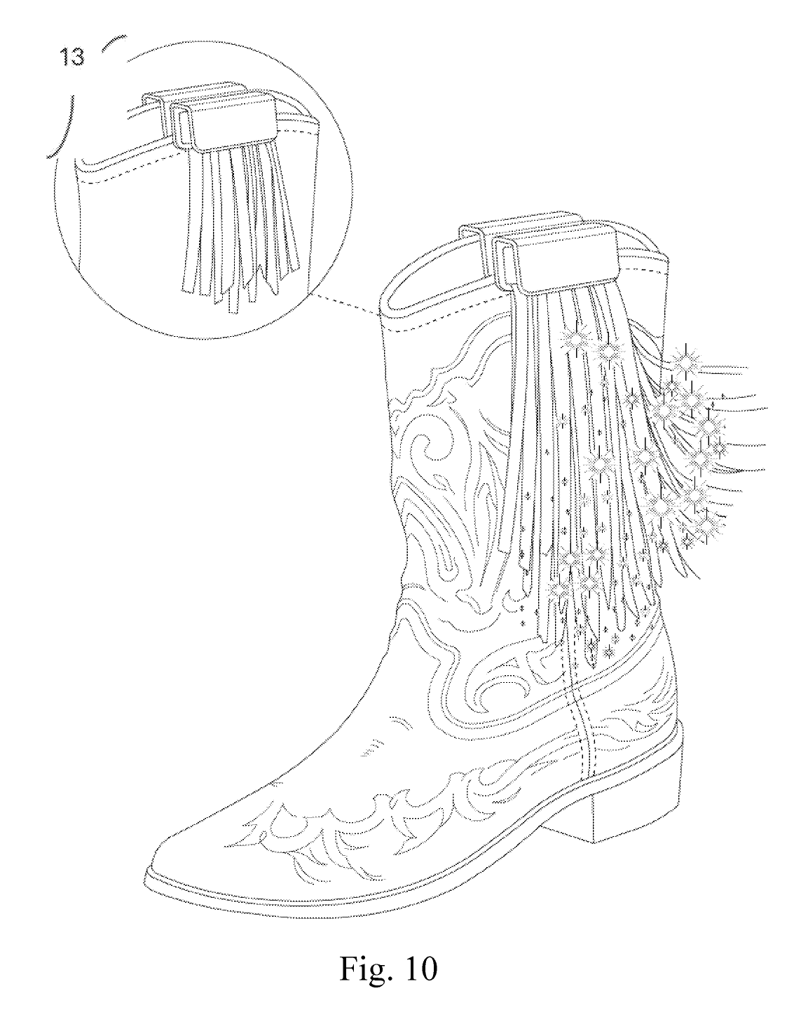

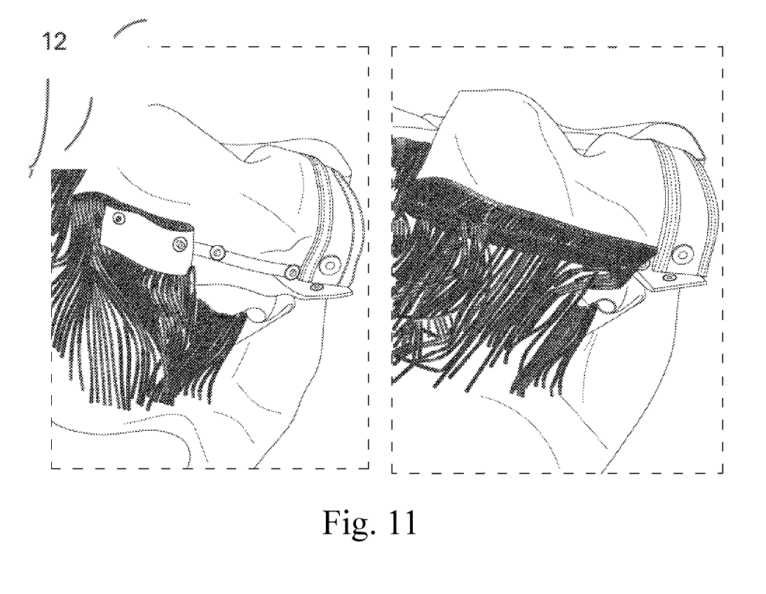

In another embodiment, the attachment mechanism comprises spring tension clips 24 configured to couple over a rim of a wearable item such as a boot or hat. Referring to FIG. 10, the spring tension clip may be configured to couple to the pull tab of a boot to attach the accessory to the boot.

In certain embodiments, the accessory 10 comprises a modular system including a base strip and one or more removable decorative layers . The base strip provides the primary structural attachment to the wearable item through clips 16 or other attachment mechanisms as previously described. The base strip includes secondary attachment points 94 configured to receive removable decorative layers.

The removable decorative layer may include fringe elements 14, trim, ornamental attachments, or other decorative features. Importantly, the decorative layer can be independently attached to and removed from the base strip without removing the base strip from the wearable item. This modularity allows users to change the appearance of the accessory by swapping different decorative layers while maintaining the base attachment.

Secondary attachment mechanisms for securing decorative layers to the base strip may include snap fasteners (male and female snap components positioned on the layer and strip respectively), hook and loop fasteners (such as Velcro® strips), magnetic fasteners (magnetic strips or discrete magnetic attachment points), button fasteners (buttonholes on one component and corresponding buttons on the other), or slide-in channels (where the decorative layer includes a rail or edge that slides into a corresponding groove on the base strip). The choice of secondary attachment mechanism may depend on the desired ease of interchange, the weight of the decorative layer, and aesthetic considerations.

The flexible material strip 12 may be contoured to conform to the specific rim configuration of each item type. Boots may have a common leather thickness typically ranging from 2-3.5mm (4-8 ounce weight). Traditional cowboy hat materials like felt range from 2-4mm thick, with higher quality hats often using thicker materials up to 6mm.

In certain embodiments, particularly when applied to boots having a shaft, the flexible material strip 12 is configured to wrap around the circumference of the boot shaft to form a decorative band that visually resembles a belt. The strip 12 may extend substantially or completely around the entire circumference of the shaft, creating a continuous decorative element that divides the boot shaft into distinct upper and lower portions. This belt-like appearance may be enhanced through the use of decorative elements such as buckles, stitching patterns, or other embellishments typically associated with belt construction.

The decorative buckle element 70, when included, may be positioned on a visible portion of the strip 12, typically on the front or side of the boot shaft where it is most visible to observers. In some embodiments, the buckle element 70 is non-functional, serving purely aesthetic purposes rather than as an actual fastening mechanism. The buckle may be made from metal, plastic, resin, or other materials and may feature various designs including western-style buckles, traditional belt buckles, ornamental clasps, or custom decorative shapes. The buckle element 70 may be permanently affixed to the strip 12 through sewing, adhesive, riveting, or may be removably attached through snap mechanisms, magnetic attachments, or other temporary fastening methods.

Decorative stitching 72 may be incorporated into the strip 12 to mimic traditional belt construction, including parallel lines of stitching along the edges of the strip, cross-hatching patterns, or ornamental stitch work. The stitching may be functional (securing layers of material together) or purely decorative (applied to the surface for visual effect), and may be executed in contrasting or complementary thread colors to enhance visibility and aesthetic appeal.

In one embodiment, the flexible material 12 includes a first face 18 and a second face 19, with the fringe element 14 coupled to the first face 18 and the clips 16 coupled to the second face 19. This configuration renders the clips substantially invisible when attached. A covering strip 17 may be attached over the clips 16 to further obscure them from view.

In another embodiment, the flexible material strip 12 features adjustable length between its first 30 and second ends 32. For example, the fabric strip may have a length of about 23.5 inches for a size 10, about 23 inches for a size 9, 22.5 inches for a size 8, etc… The system includes a first clip secured to the first end 30 and a second clip configured for user attachment to the second end 32, enabling customization for different item sizes. Spacing between clips along the flexible material strip 12 may be adjusted to keep spacing consistent.

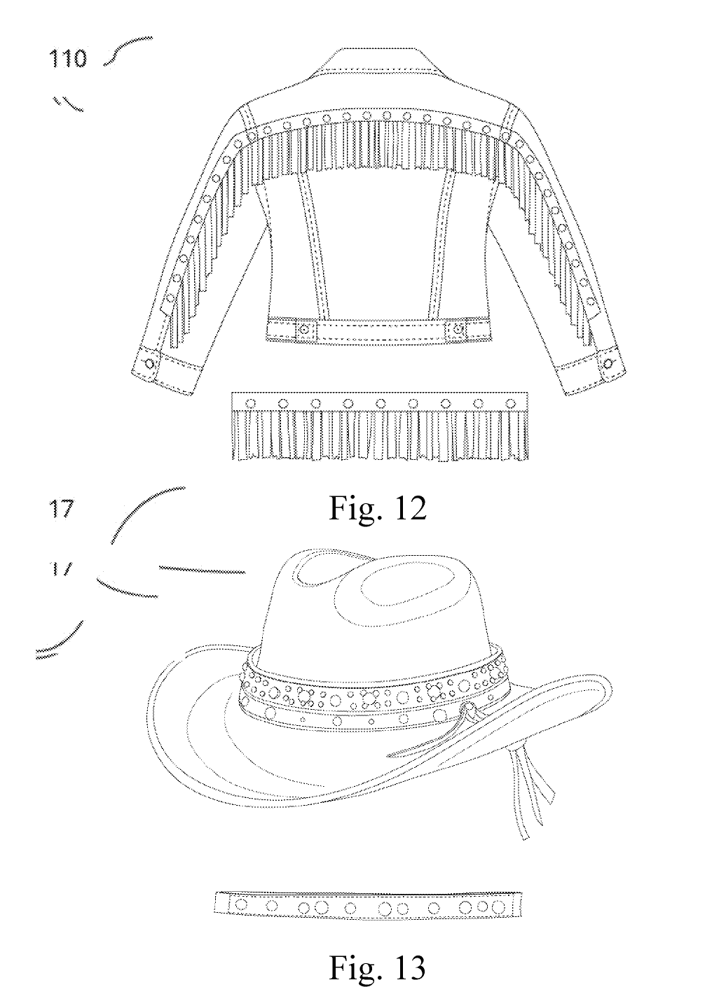

Referring to FIG. 12, the accessory 10 may include one or more fringe bars 110 that are removably attachable to the strip of flexible material 12. Each fringe bar 110 comprises an elongated support element 12 from which fringe element 14 extends. The fringe bar 110 includes snap-on connectors 16 configured to engage with corresponding connectors positioned on the strip wearable item.

The snap-on connectors 114 may be mechanical snaps (such as ball-and-socket snaps, spring-loaded clips, or friction-fit projections), magnetic connectors (magnetic elements embedded in both the bar and strip), or hook-and-channel systems (where projections on one component engage with slots or channels on the other). The connectors are positioned at regular intervals along the fringe bar 110, typically near the ends and optionally at intermediate points, to ensure secure attachment along the length of the bar.

Multiple fringe bars with different decorative appearances may be provided, allowing users to interchange bars to achieve different looks. For example, one fringe bar might feature long leather fringe in a natural color, another might feature shorter synthetic fringe in a bright color, and a third might feature feathered fringe for a different texture. Users can quickly snap off one fringe bar and snap on another to change the appearance of the accessory without removing the base strip 12 from the wearable item.

The fringe bar 110 may be rigid (maintaining a fixed shape), semi-rigid (having some flexibility while maintaining general shape), or flexible (conforming to the contour of the attachment surface). Materials for the fringe bar support element 112 may include plastic, metal, composite materials, stiffened fabric, or leather with internal reinforcement.

Referring to FIG. 13, in one embodiment, the flexible strip 12 may be a loop configured to fit about the head portion of a hat. The flexible strip 12 may have magnetic strip connecting points 17. Fringe elements 14 can have fringe connecting points 19 that couple with the strip connecting points 17 to optionally connect to the hat. Other decorative elements can be connected to the strip connecting points with their own magnetic connectors.

A light up accessory 13 may be used in conjunction with the flexible material strip 12. For example, the flexible material strip 12 may include a pocket 100 to hold a battery pack 102. The battery pack 102 is situated to be hidden from view when the fabric strip 12 is affixed about the boot. The battery pack 102 is coupled to at least one light source 104. The at least one light source 104 is coupled to a plurality of fiber optic strands 106 that light up when the light source 104 is illuminated. The light source 104 may be one or more LED lights or any other light source known to those having skill in the art.

The accessory 10 may incorporate multiple tiers or layers of decorative elements to create visual depth and interest. In a multi-tier configuration, a plurality of fringe elements 14 are arranged at different heights relative to the flexible material strip 12. For example, a first fringe element 14a may be positioned at a first height, extending from a first attachment line on the strip 12, while a second decorative element 14b is positioned at a second height, extending from a second attachment line on the strip 12. The different heights may be achieved by attaching the fringe elements to different positions on the strip, by using fringe elements of different lengths, or by incorporating intermediate support structures.

In layered configurations, fringe elements are positioned to overlay one another. A first layer 14a of fringe may extend from the strip 12, and a second layer 14b of fringe may be positioned over the first layer, creating a cascading or stacked effect. The layers may use different materials, colors, lengths, or densities to create visual contrast. For instance, a bottom layer might feature longer leather fringe while a top layer features shorter metallic fringe, or vice versa. The layering may be achieved through sequential attachment to the strip 12 at slightly offset positions, through attachment to separate base structures that are themselves layered, or through the use of intermediate mounting bars or strips.

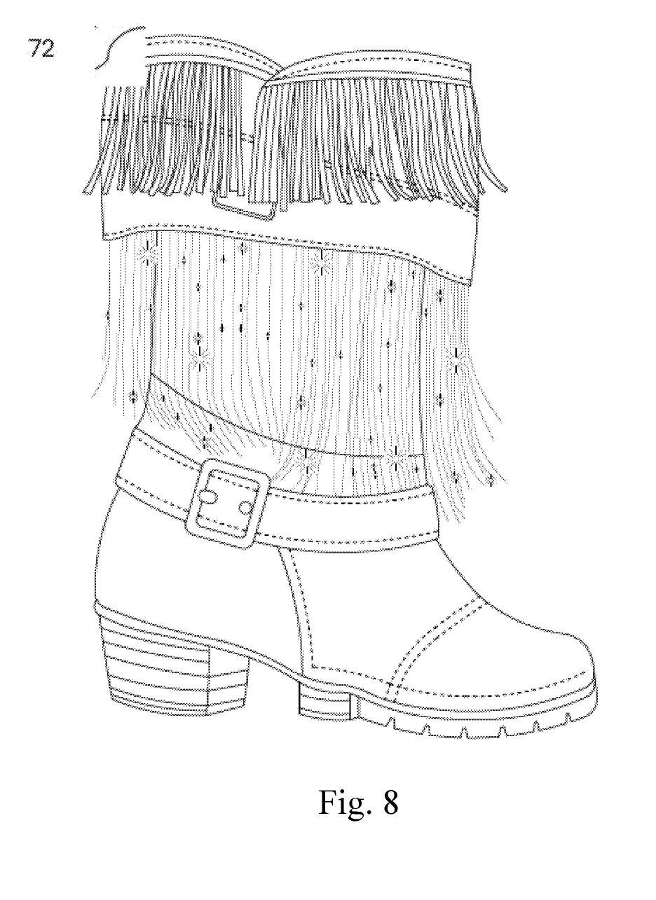

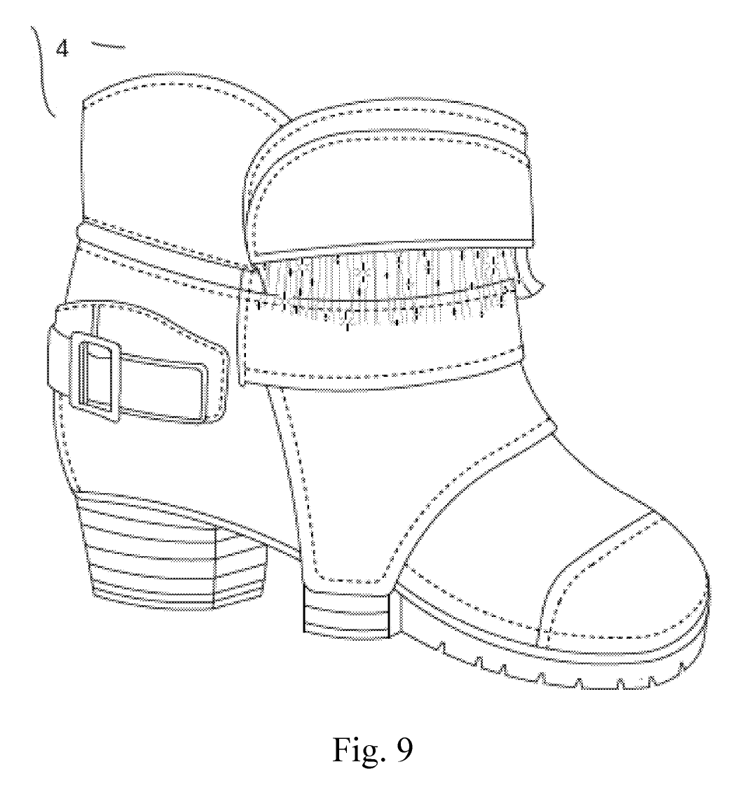

Referring to FIGS. 8, the accessory may include a fabric strip 12 having both an unlighted fringe element 14 and a light up accessory 13. The fabric strip 12 may comprise an elastic loop that is sized to fit around the shaft of a boot and constrict to secure the accessory to the boot shaft.

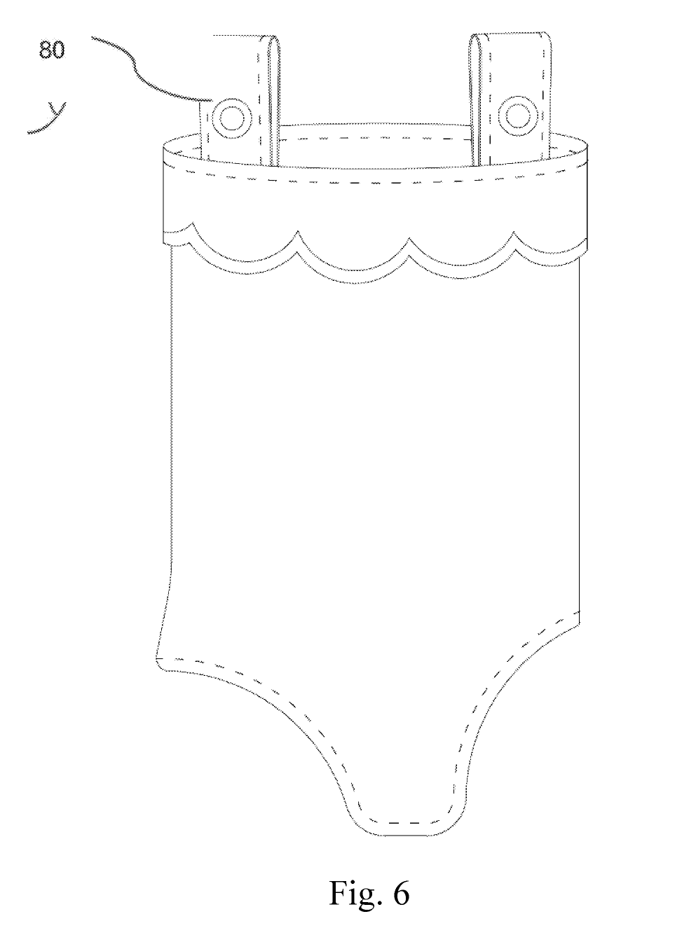

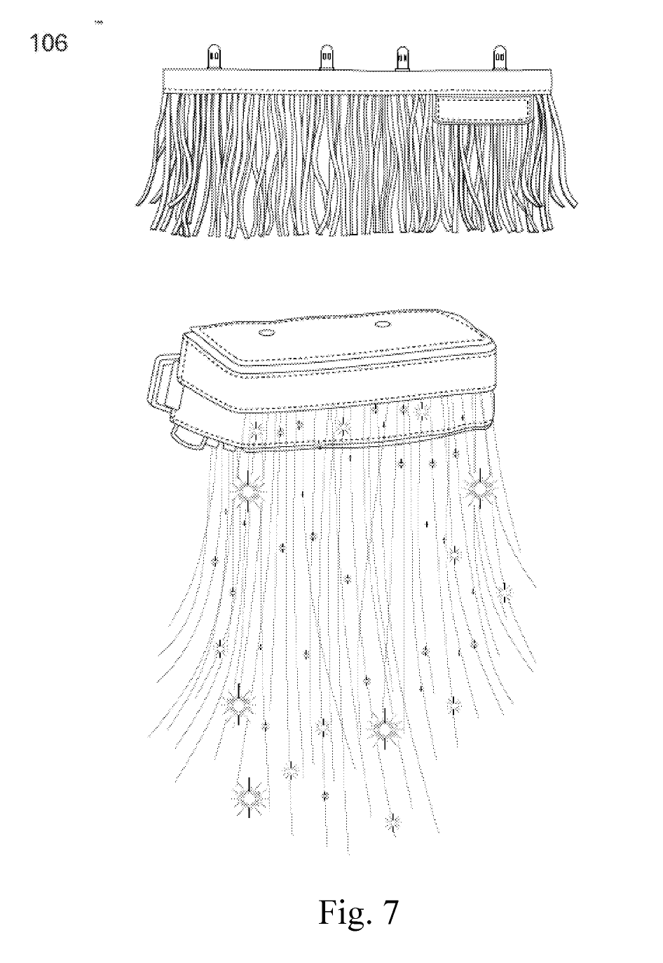

Referring to in particular to FIG. 6, The fringe element 14 may be attached using an interchangeable sleeve 40 having a top 42, a bottom 44, a front 46, and a back 48. The sleeve 40 has a front end 50 near the front 46 and a back end 52 near the back 48. The sleeve 40 may have at least one pull tab 54 extending from the top of the sleeve 40. The pull tabs 54 may have an accessory tab attachment 56. A corresponding boot tab attachment may be on the pull tabs of the footwear and the accessory may be coupled to the footwear by engaging the accessory tab attachment 56 with the footwear tab attachment. In a particular embodiment, the tab attachment is a snap rivet. An extending snap rivet may be coupled to the boot tab and a receiving snap rivet attached to the pull tabs 54. The extending snap rivet engages the receiving snap rivet to secure the accessory to the footwear. The bottom 44 of the sleeve 40 may have a contour 60 comprising a front cutout 62 and a back cutout 64 with an extension 66 between the front cutout 54 and the back cutout 56. The back cutout 56 may extend higher up the sleeve 40 than the front cutout 54 to accommodate the larger back portion of the footwear to which the sleeve 40 is attached.

The interchangeable sleeve may have a decorative outer surface 80 that may include trim, fringe, or illuminating decorative elements.

The above and other objects may be achieved using methods involving attaching temporary accessories to wearable items. The method includes providing a strip of flexible material designed to conform to an accessorizable area of a wearable item. A fringe element is secured to the flexible material strip such that it extends outward, and at least one clip is attached to enable removable attachment to the wearable item.

In one embodiment, the clip comprises an extending rivet 22 that couples with a receiving rivet 20 secured to the wearable item. The flexible material strip may be contoured to match the rim of wearable items such as jackets, hats, or boots.

The method includes designing the flexible material with two faces - a first face supporting the fringe element and a second face supporting the clips. This configuration conceals the clips when the accessory is attached to the wearable item.

In another embodiment, the strip has an adjustable length, allowing users to customize the fit for different wearable items. Users receive instructions for both adjusting the strip length and properly securing the clips to the accessorizable area.

The method enables secure but temporary attachment while maintaining aesthetic appeal through concealed fastening mechanisms. The system accommodates various wearable items without requiring permanent modification.

In certain embodiments, the accessory 10 includes multiple decorative elements that are each independently attachable to the flexible material strip 12. For example, a first decorative element comprising traditional fringe may be coupled to the strip 12 at a first set of attachment points, while a second decorative element comprising illumination elements is independently attachable to the strip 12 at a second set of attachment points. When both elements are attached, the second decorative element may be layered over the first decorative element.

The independent attachability allows users to customize the accessory by choosing which decorative elements to include. A user might attach only the fringe element for a traditional look, only the illumination element for a modern light-up effect, or both elements together for a combined effect. Each decorative element can be independently removed without removing the other elements or the base strip 12 from the wearable item.

The attachment points for each decorative element may be interleaved along the strip 12, grouped in separate zones, or arranged in any configuration that allows independent access to each element's fasteners. For instance, the first decorative element 120 might attach via snap fasteners positioned along the top edge of the strip 12, while the second decorative element 122 attaches via magnetic fasteners positioned along the bottom edge of the strip 12.

Multi-tier fringe configurations may be constructed using several methods. In a sequential attachment method, fringe elements are sewn or attached to the base strip 12 in sequence, with each subsequent tier positioned slightly higher or lower than the previous tier. The offset may be as small as 1-2 mm for subtle layering or as large as 25-50 mm for pronounced tier separation.

In an intermediate support method, short strips or bars are first attached to the base strip 12 at different heights, and then fringe elements are attached to these intermediate supports. This allows for precise control of tier positioning and makes it easier to replace individual tiers.

In a folded construction method, the base strip 12 itself is folded or pleated to create multiple surfaces at different heights, with fringe elements attached to each surface. This method integrates the tier structure into the base strip itself.

In closing, it is to be understood that although aspects of the present specification are highlighted by referring to specific embodiments, one skilled in the art will readily appreciate that these disclosed embodiments are only illustrative of the principles of the subject matter disclosed herein. Therefore, it should be understood that the disclosed subject matter is in no way limited to a particular methodology, protocol, and/or reagent, etc., described herein. As such, various modifications or changes to or alternative configurations of the disclosed subject matter can be made in accordance with the teachings herein without departing from the spirit of the present specification. Lastly, the terminology used herein is for the purpose of describing particular embodiments only and is not intended to limit the scope of the present disclosure, which is defined solely by the claims. Accordingly, embodiments of the present disclosure are not limited to those precisely as shown and described.

Certain embodiments are described herein, including the best mode known to the inventors for carrying out the methods and devices described herein. Of course, variations on these described embodiments will become apparent to those of ordinary skill in the art upon reading the foregoing description. Accordingly, this disclosure includes all modifications and equivalents of the subject matter recited in the claims appended hereto as permitted by applicable law. The terms “including” and “such as” are not limiting and should be interpreted as “including, but not limited to,” and “such as, for example,” respectively. Moreover, any combination of the above-described embodiments in all possible variations thereof is encompassed by the disclosure unless otherwise indicated herein or otherwise clearly contradicted by context.

I claim:

1. An attachable temporary accessory for wearable items having an accessorizable area, the accessory comprising:
a strip of flexible material configured to conform to the accessorizable area;
a fringe element sewn to and extending from the flexible material;
at least one clip coupled to the flexible material and configured to removably attach the flexible material to the accessorizable area.

2. The attachable temporary accessory of claim 1 further comprising a receiving rivet or an extending rivet configured to attach to a textile that makes up the wearable item and wherein the clip is a receiving rivet or an extending rivet that detachably couples to the receiving rivet or extending rivet of the wearable item.

3. The attachable temporary accessory of claim 1, wherein the wearable item has a rim or a pull tab and wherein the at least one clip is a spring tension clip that is configured to couple over the rim or the pull tab.

4. The attachable temporary accessory of claim 3 wherein the wearable item is a boot and wherein the strip of flexible material is contoured to conform to the rim of the boot.

5. The attachable temporary accessory of claim 1 wherein the wearable item is a hat and wherein the strip of flexible material is a loop and further comprising at least one magnetic attachment point.

6. The attachable temporary accessory of claim 5 further comprising at least one additional decorative element interchangeably connectable to the at least one magnetic attachment point.

7. The attachable temporary accessory of claim 1 wherein the flexible material has a first face and a second face and wherein the fringe element is coupled to the first face and the at least one clip is coupled to the second face such that the at least one clip is substantially invisible when the at least one clip is attached to the wearable item.

8. The attachable temporary accessory of claim 1 wherein the fringe element defines a first decorative layer and wherein the accessory further comprises a second decorative layer.

9. The attachable temporary accessory of claim 8, wherein the second decorative layer is lighted.

10. The attachable temporary accessory of claim 8, wherein the second decorative layer is detachable.

11. The attachable temporary accessory of claim 1, wherein the flexible material has a first end and a second end, and wherein the at least one clip comprises first clip secured to the first end and a second clip configured to be secured to the second end by a user.

12. The attachable temporary accessory of claim 1, further comprising a covering strip that is attached to the strip of flexible material over the at least one clip to obscure the at least one clip from view.

13. The attachable temporary accessory of claim 1, wherein the wearable item has a shaft, and wherein the flexible material wraps fully or substantially fully around the shaft.

14. The attachable temporary accessory of claim 1 further comprising a decorative buckle.

15. A method of attaching a temporary accessory to a wearable item having an accessorizable area, the method comprising the acts of:
providing a strip of flexible material
configuring the strip of flexible material to conform to the accessorizable area;
securing a fringe element to the strip of flexible material such that the fringe extends from the flexible material;
securing at least one clip to the flexible material that is configured to removably attach the flexible material to the accessorizable area;
instructing a user to secure the clip to the accessorizable area.

16. The method of claim 15 wherein the at least one clip is at least one extending rivet that couples to a receiving rivet, the method further comprising securing the at least one receiving rivet to the wearable item.

17. The method of claim 15 wherein the method further comprises contouring the strip of flexible material to match the contour of a rim of the wearable item.

18. The method of claim 15 further comprising coupling an illumination system to the flexible material.

19. The method of claim 15 further comprising permanently attaching to the wearable item at least one corresponding clip that corresponds to the clip secured to the flexible material.

20. An interchangeable accessory for footwear, the accessory comprising:
a sleeve having a top, a bottom, a front, and a back, the sleeve configured to fit over a portion of the footwear;
at least one pull tab extending from the top of the sleeve;
an accessory attachment tab coupled to the at least one pull tab and configured to engage with a corresponding footwear tab attachment;
wherein the bottom of the sleeve has a contoured shape comprising a front cutout and a back cutout with an extension between the front cutout and the back cutout.

21. The accessory of claim 20 wherein the accessory attachment tab is a button rivet element configured to engage with a corresponding footwear button rivet element.

22. The accessory of claim 20 further comprising comprising a decorative outer surface comprising at least one element selected from the group consisting of trim, fringe, and illuminating decorative elements.

23. A method for providing a removable decorative accessory system for a garment, the method comprising the acts of:
providing a decorative strip having a first surface, a second surface, at least one decorative element and at least one riveted coupling member coupled to the decorative strip the riveted coupling member configured to engage a corresponding receiver on the garment; and
securing the at least one corresponding receiver along seam, yoke, shoulder line, sleeve seam, or other defined region of the garment;
wherein the decorative strip is removably attachable to the garment without permanent alteration of the garment;.
